(19) United States
(12) Patent Application Publication
(10) Pub. No.: US 2014/0358494 A1
(43) Pub. Date: Dec. 4, 2014

(54) DEFORMATION SIMULATION APPARATUS, DEFORMATION SIMULATION METHOD, AND DEFORMATION SIMULATION PROGRAM

(71) Applicant: FUJITSU LIMITED, Kawasaki-shi (JP)

(72) Inventors: Kanako IMAI, Sagamihara (JP); Shigeo ISHIKAWA, Kawasaki (JP)

(73) Assignee: FUJITSU LIMITED, Kawasaki-shi (JP)

(21) Appl. No.: 14/272,574

(22) Filed: May 8, 2014

(30) Foreign Application Priority Data
May 28, 2013 (JP) 2013-112392

(51) Int. Cl. G06F 17/50

(52) U.S. Cl. CPC G06F 17/5009
USPC 703/1; 703/6; 703/2

(57) ABSTRACT

A deformation simulation apparatus includes a simulation unit configured to simulate a deformation of an elastic body to determine a plurality of simulated results, the plurality of simulated results being simulated at respective a plurality of positions in the elastic body, a display unit configured to display a graph that is indicative of the plurality of simulated results in a manner that each of the plurality of simulated results is associated with a corresponding one of the plurality of positions over a range indicative of a whole of the elastic body.

### CROSS-REFERENCE TO RELATED APPLICATION

This application is based upon and claims the benefit of priority of the prior Japanese Patent Application No. 2013-112392, filed on May 28, 2013, the entire contents of which are incorporated herein by reference.

### FIELD

The embodiment discussed herein is related to a deformation simulation apparatus, a deformation simulation method, and a deformation simulation program.

### BACKGROUND

In general, when external pressure is applied to elastic bodies, the elastic bodies deform and stress is generated in the elastic bodies. For example, to ensure air sealing by a packing used in a state in which the packing is sandwiched between components, pressure above a certain level is applied to surfaces of the sandwiched packing. When pressure of certain intensity or more is not applied, gaps are generated between the packing and the components due to pressure of internal or external liquid or gas, and accordingly, the liquid or the gas leaks. Therefore, it is important to evaluate a surface pressure of the packing by numerical simulation.

FIG. 17 is a diagram illustrating an example of a shape of a packing. The packing illustrated in FIG. 17 is used between upper and lower case components of a cellular phone. As illustrated in FIG. 17, a packing 8 used between upper and lower case components of a cellular phone has uniform cross-sections and an elongated shape.

Air sealing will be maintained when a largest value of a packing surface pressure ensures a requisite surface pressure at any cross-sections of the packing. Therefore, in order to ensure the air sealing in the entire packing, the requisite surface pressure is ensured in all arbitrary cross-sectional positions located along the elongated shape of the packing.

To evaluate largest values of surface pressures in the arbitrary cross-sections, surface pressure distribution of the entire packing is used. FIG. 18 is a diagram illustrating an example of display of surface pressure distribution of the entire packing. A designer searches the display of the surface pressure distribution illustrated in FIG. 18 for the smallest one of largest values of the surface pressures at each of cross-sections, while portions of the display are enlarged. In actual display of the surface pressure distribution, an enlarged portion 9 is displayed such that surface pressures of individual meshes 10 are represented by colors, and the designer recognizes the surface pressures in various portions with reference to display of associations between the colors and the surface pressures.

In a related art, stress and deformation generated when two objects separately located have contact with each other due to heat or a load are obtained by a finite element method and the obtained stress and the obtained deformation are displayed in a graph. Furthermore, in another related art, the relationship between a share force which is obtained from a bearing force of walls of a building and an amount of displacement and the relationship between a share force at a time of earthquake and a displacement curve are displayed in a graph in an overlapping manner.

Japanese Laid-open Patent Publication Nos. 9-145493 and 2002-73698 disclose the related arts.

### SUMMARY

According to an aspect of the invention, a deformation simulation apparatus includes a simulation unit configured to simulate a deformation of an elastic body to determine a plurality of simulated results, the plurality of simulated results being simulated at respective a plurality of positions in the elastic body, a display unit configured to display a graph that is indicative of the plurality of simulated results in a manner that each of the plurality of simulated results is associated with a corresponding one of the plurality of positions over a range indicative of a whole of the elastic body.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration of a deformation simulation apparatus according to an embodiment;

FIG. 2 is a diagram illustrating mesh generated for a packing;

FIG. 3 is a diagram illustrating an example of a data configuration of an analysis result storage unit;

FIG. 4 is a diagram illustrating nodes;

FIG. 5 is a diagram illustrating a packing route of the packing illustrated in FIG. 2;

FIG. 6A is a sectional view illustrating upper and lower cases of a cellular phone and the packing;

FIG. 6B includes enlarged views of a portion in the vicinity of the packing;

FIG. 7 is a diagram illustrating generation of mesh including nodes generated in cross-sectional positions which are vertical to the packing route;

FIG. 8 is a diagram illustrating a method for calculating a coordinate in a packing height direction after deformation;

FIG. 9 is a diagram illustrating an example of a deformation cross-sectional view displayed by a result display unit;

FIG. 10 is a diagram illustrating an example of a graph displayed by the result display unit;

FIG. 11 is a diagram illustrating an example of conjunction display displayed by the result display unit;

FIG. 12 is a diagram illustrating an example of conjunction display of a deformation cross-sectional view and a graph obtained when a pointer moves;

FIG. 13 is a flowchart illustrating a flow of a process performed by the deformation simulation apparatus;

FIG. 14 is a flowchart illustrating a processing flow of definition of vertical cross-sections and calculation of display values;

FIG. 15 is a flowchart illustrating a processing flow of the conjunction display performed by the result display unit;

FIG. 16 is a diagram illustrating a hardware configuration of a computer which executes a deformation simulation program;

FIG. 17 is a diagram illustrating an example of a shape of a packing; and

FIG. 18 is a diagram illustrating an example of display of surface pressure distribution of an entire packing.

### DESCRIPTION OF EMBODIMENTS

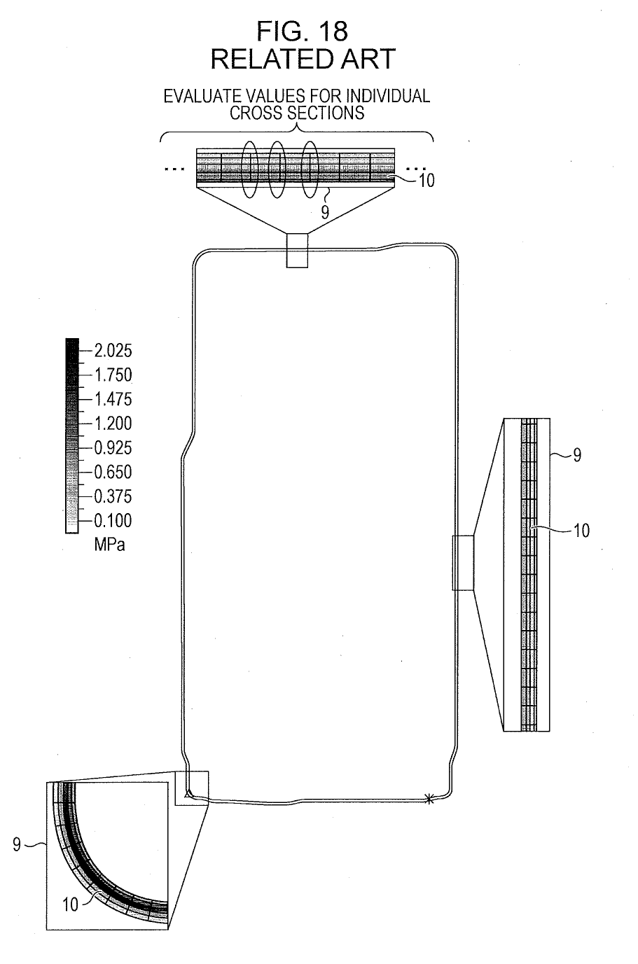

When using a conventional apparatus, in the surface pressure distribution of the entire packing illustrated in FIG. 18, the designer may not recognize the smallest one of the largest surface pressures in the cross-sections of various portions unless enlarged display is performed. Accordingly, the designer searches for the smallest one of the largest surface pressures, each of which is the largest surface pressure at a cross-section of the packing, by repeatedly resizing and shifting a portion of a distribution diagram. As a result, a problem arises in that the designer may not efficiently searches for a portion corresponding to the smallest one of the largest surface pressures.

Accordingly, it is preferable to provide surface pressure display which allows a designer to efficiently search for a portion in which stress generated in an elastic body has a certain characteristic in the entire elastic body, such as a portion corresponding to a smallest one of largest surface pressures of a packing.

Hereinafter, an embodiment of a deformation simulation apparatus, a deformation simulation method, and a deformation simulation program disclosed in this application will be described in detail with reference to the accompanying drawings. In the embodiment, a case where deformation of a packing 8 which is sandwiched between upper and lower cases of a cellular phone is simulated will be described. Furthermore, the disclosed technique is not limited to the embodiment.

### Embodiment

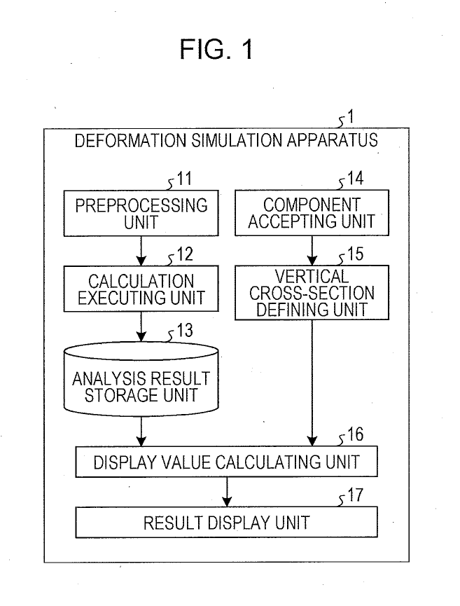

First, a functional configuration of the deformation simulation apparatus according to the embodiment will be described. FIG. 1 is a block diagram illustrating a functional configuration of the deformation simulation apparatus according to the embodiment. As illustrated in FIG. 1, a deformation simulation apparatus 1 includes a preprocessing unit 11, a calculation executing unit 12, an analysis result storage unit 13, a component accepting unit 14, a vertical cross-section defining unit 15, a display value calculating unit 16, and a result display unit 17.

The preprocessing unit 11 performs preprocessing necessary for numerical simulation of deformation of the packing. Specifically, the preprocessing unit 11 performs generation of mesh for the packing 8 and components which sandwich the packing 8, and posing a constraint upon the packing 8 and the components which sandwich the packing 8.

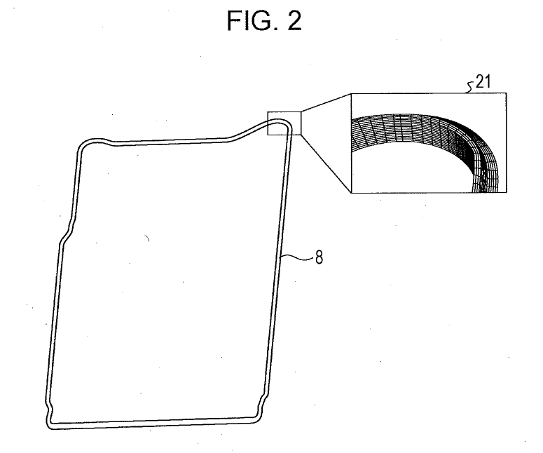

FIG. 2 is a diagram illustrating the mesh generated for the packing 8. As illustrated in an enlarged portion 21 of FIG. 2, the preprocessing unit 11 generates mesh for the packing 8 and the case components of the cellular phone which sandwich the packing 8.

The calculation executing unit 12 executes calculation of the numerical simulation of deformation of the packing 8 sandwiched between the upper and lower case components of the cellular phone by using the mesh generated by the preprocessing unit 11 and a boundary condition set by the preprocessing unit 11. Thereafter, the calculation executing unit 12 leads the results of the calculation of the numerical simulation to the analysis result storage unit 13 to store the results.

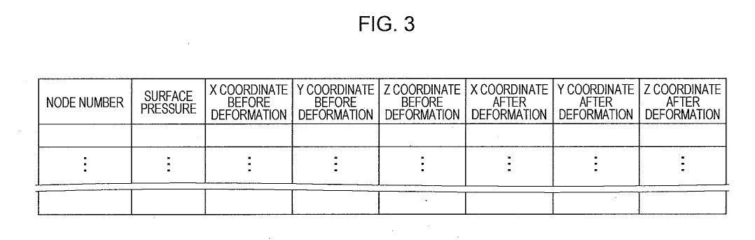

The analysis result storage unit 13 stores the results of the calculation performed by the calculation executing unit 12 as analysis results. FIG. 3 is a diagram illustrating an example of a data configuration in the analysis result storage unit 13. As illustrated in FIG. 3, the analysis result storage unit 13 stores a node number, a surface pressure, an X coordinate before deformation, a Y coordinate before deformation, a Z coordinate before deformation, an X coordinate after deformation, a Y coordinate after deformation, and a Z coordinate after deformation which are associated with one another.

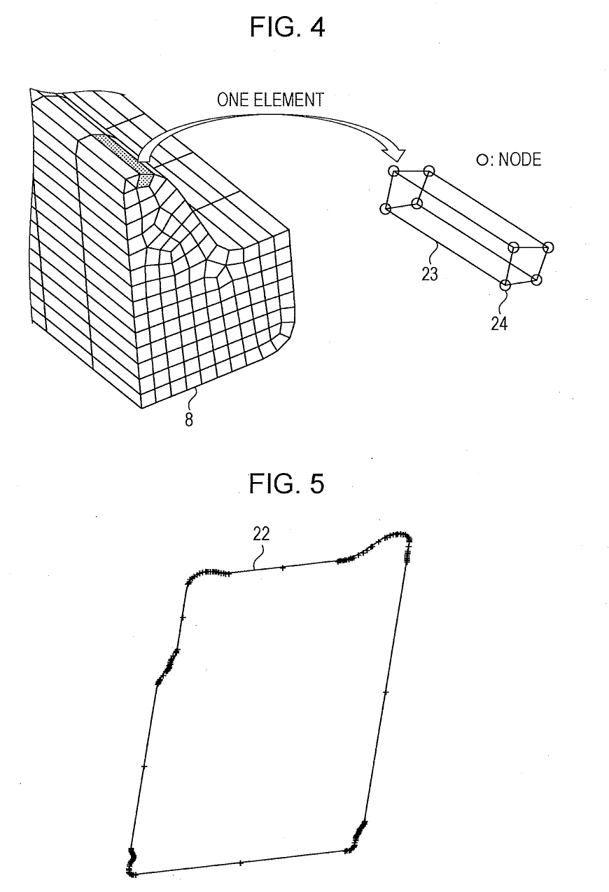

The node number represents an identification number which identifies a node. Here, the node represents an apex of element defined by the mesh for the packing 8. FIG. 4 is a diagram illustrating nodes. As illustrated in FIG. 4, an element 23 is defined in the packing 8 and apexes of the element 23 correspond to nodes 24.

The surface pressure represents a surface pressure on one of the nodes 24 identified by the node number. The X, Y, and Z coordinates before deformation represent X, Y, and Z coordinates of one of the nodes 24 before the packing 8 deforms, respectively, and the X, Y, and Z coordinates after deformation represent X, Y, and Z coordinates of one of the nodes 24 after the packing 8 deforms, respectively.

Returning to FIG. 1, the component accepting unit 14 displays an analysis model on a screen of a display apparatus and accepts designation by a designer to set the analysis model as the packing 8.

The vertical cross-section defining unit 15 automatically obtains a plurality of cross-sections which are vertical to a packing route of the packing 8 accepted by the component accepting unit 14. Note that the term “packing route” represents a route extending longitudinally along a shape of the packing 8.

FIG. 5 is a diagram illustrating a packing route 22 of the packing 8 illustrated in FIG. 2. The vertical cross-section defining unit 15 automatically obtains a plurality of cross-sections which are vertical to the packing route 22 at an interval specified by the designer from a start position which is preset in the packing 8.

The display value calculating unit 16 extracts information on the nodes 24 which are located in cross-sectional positions obtained by the vertical cross-section defining unit 15 from the analysis result storage unit 13 and calculates the largest surface pressure on and a crushing amount in each of the vertical cross-sections in the cross-sectional positions by using the extracted information. Note that the preprocessing unit 11 generates the nodes 24 at the cross-sectional positions which are vertical to the packing route 22 when the mesh is generated in order to facilitate the extraction of the largest surface pressures and the crushing amounts performed by the display value calculating unit 16.

In more detail, the display value calculating unit 16 obtains the largest one of surface pressures on the nodes 24 in the cross-sectional position obtained by the vertical cross-section defining unit 15 as the largest surface pressure on the cross-sectional position. Furthermore, the display value calculating unit 16 obtains crushing amount in accordance with heights of the packing 8 before and after deformation.

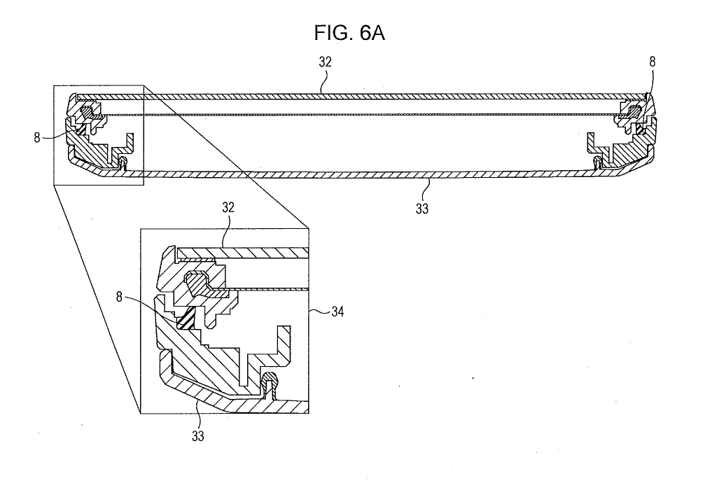

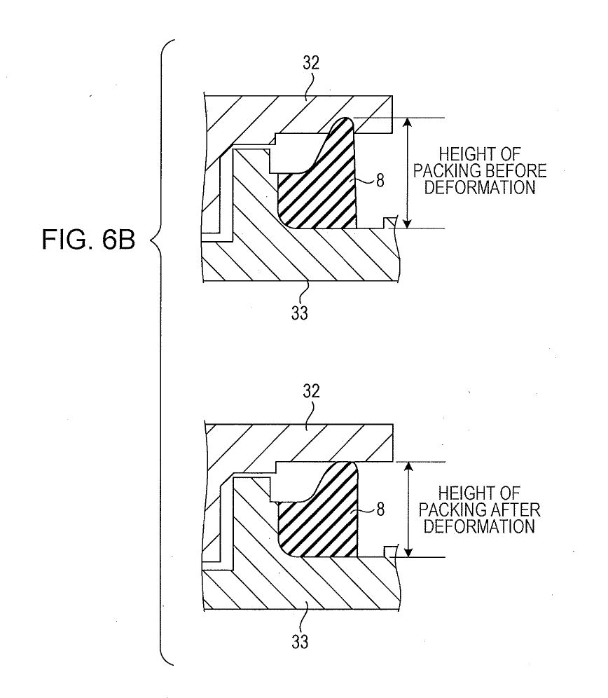

FIGS. 6A and 6B are diagrams illustrating a crushing amount. FIG. 6A is a sectional view illustrating upper and lower cases 32 and 33 of the cellular phone and the packing 8. FIG. 6B is an enlarged view illustrating a portion in the vicinity of the packing 8. As illustrated in FIG. 6A, the packing 8 is sandwiched between the upper and lower cases 32 and 33 of the cellular phone. Furthermore, an enlarged portion 34 represents a left end of the sectional view in an enlarged manner.

In FIG. 6B, a portion in the vicinity of the packing 8 is further enlarged. In FIG. 6B, a diagram on a left side represents a height of the packing 8 before deformation and a diagram on a right side represents a height of the packing 8 after deformation. A crushing amount is represented by a value obtained by subtracting the height of the packing 8 after deformation from the height of the packing 8 before deformation.

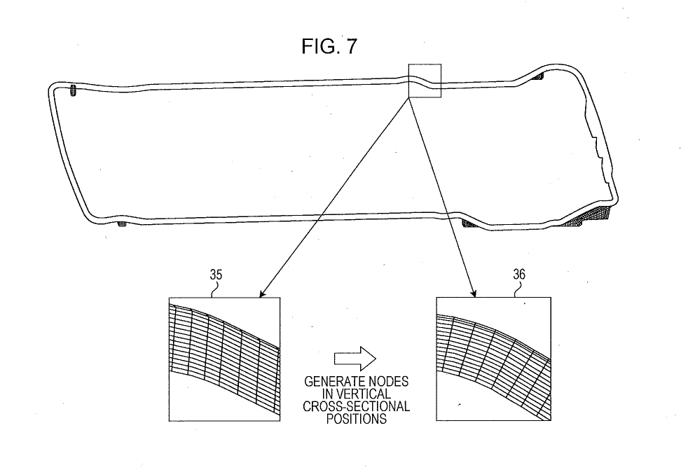

FIG. 7 is a diagram illustrating generation of the mesh including the nodes 24 generated in the cross-sectional positions which are vertical to the packing route 22. Enlarged portions 35 and 36 of FIG. 7 represent mesh generated in a slope portion of the packing 8. In FIG. 7, the enlarged portion 35 represents a case where the preprocessing unit 11 generates the nodes 24 in cross-sectional positions which are not vertical to the packing route 22, and the enlarged portion 36 represents a case where the preprocessing unit 11 generates the nodes 24 in cross-sectional positions which are vertical to the packing route 22.

When the preprocessing unit 11 generates the nodes 24 in the cross-sectional portions in the slope portion of the packing 8 which are vertical to the packing route 22, the nodes 24 are disposed on the cross-sections defined by the vertical cross-section defining unit 15. Accordingly, the display value calculating unit 16 extracts the nodes 24 located in each of the cross-sections defined by the vertical cross-section defining unit 15 from the analysis result storage unit 13 in accordance with coordinates of the nodes 24. Further, the display value calculating unit 16 determines a largest one of surface pressures for each of the cross-sections of the extracted nodes 24 as each of the largest surface pressures for each of the cross-sectional positions.

Furthermore, the display value calculating unit 16 may extract the nodes 24 located in each of the cross-sections defined by the vertical cross-section defining unit 15 from the analysis result storage unit 13 in accordance with the coordinates of the nodes 24 and calculate crushing the amount of each of the cross-sections using the coordinates of the extracted nodes 24 before and after deformation.

When the preprocessing unit 11 generates the nodes 24 in cross-sectional positions which are not vertical to the packing route 22, the display value calculating unit 16 calculates coordinates on cross-sections defined by the vertical cross-section defining unit 15 in accordance with information on the nodes 24 located in the vicinity of the coordinates.

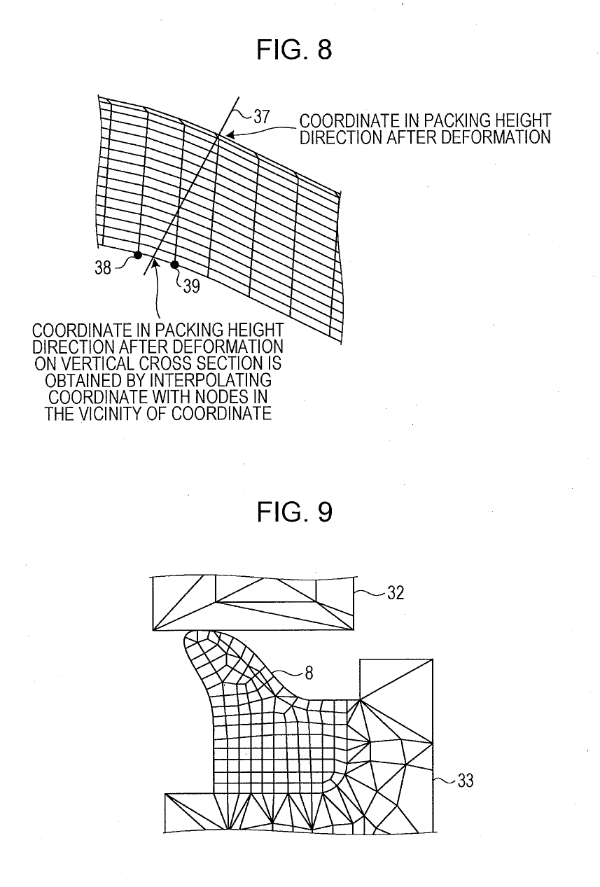

FIG. 8 is a diagram illustrating a method for calculating a coordinate in a packing height direction after deformation. As illustrated in FIG. 8, when the nodes 24 are not located in cross-sectional positions vertical to the packing route 22, an axis 37 supposed to locate on the cross-section and pass through nodes 24 before the deformation locates off the one of nodes 24. In this case, the display value calculating unit 16 obtains a coordinate of the axis 37 in the packing height direction after deformation on a cross section which is vertical to the packing route 22 by interpolating the coordinate with coordinates of two nodes 38 and 39 located in the vicinity of the coordinate as illustrated in FIG. 8.

Returning to FIG. 1, the result display unit 17 displays a deformation cross-sectional view in the display apparatus in accordance with information on the cross-sectional positions extracted from the analysis result storage unit 13 by the display value calculating unit 16. Here, the deformation cross-sectional view represents a cross-sectional view in a state in which the packing 8 is deformed.

FIG. 9 is a diagram illustrating an example of the deformation cross-sectional view displayed by the result display unit 17. As illustrated in FIG. 9, the result display unit 17 displays the deformation cross-sectional view including the upper case 32, the lower case 33, and the deformed packing 8 in a certain cross-sectional position.

In an actual screen, sectional views of the upper case 32, the lower case 33, and the packing 8 are displayed preferably in different colors. Furthermore, the sectional view of FIG. 9 corresponds to a right portion of the sectional view illustrated in FIG. 6A.

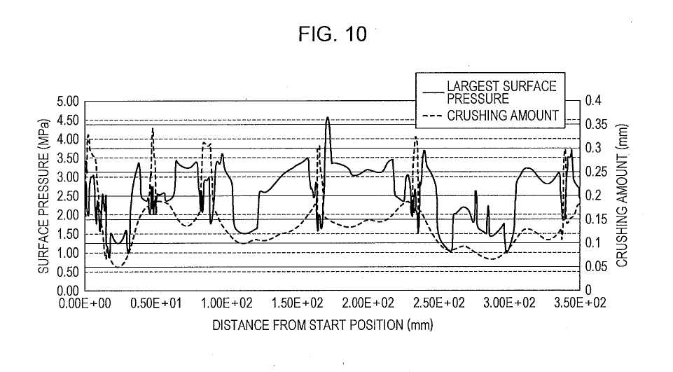

The result display unit 17 displays the largest surface pressure and the crushing amount of each of the cross-sections in the entire packing 8 in a graph in accordance with the largest surface pressure on and the crushing amount in each the cross-sectional position calculated by the display value calculating unit 16. FIG. 10 is a diagram illustrating an example of the graph displayed by the result display unit 17.

In FIG. 10, an axis of abscissa represents a distance from a start position, an axis of ordinate on a left side represents a surface pressure, and an axis of ordinate on a right side represents a crushing amount. Here, the start point is determined in advance in a certain position of the packing 8. A unit of the distance is “mm”, a unit of the surface pressure is “MPa”, and a unit of the crushing amount is “mm”.

Since the result display unit 17 displays the largest surface pressures and the crushing amounts of each of the cross-sectional positions of the entire packing 8 in the graph in accordance with the largest surface pressures on and the crushing amounts in the cross-sectional positions located at a regular interval, the designer may efficiently search for a portion corresponding to the smallest one of the largest surface pressures. Furthermore, the designer may also recognize a crushing amount of the portion corresponding to the smallest one among the largest surface pressures. In the graph of FIG. 10, the largest surface pressures at each of the cross-sectional positions are denoted by a solid line and the crushing amounts at each of the cross-sectional positions are denoted by a dotted line. However, in an actual screen, the two lines in the graph are displayed preferably in different colors.

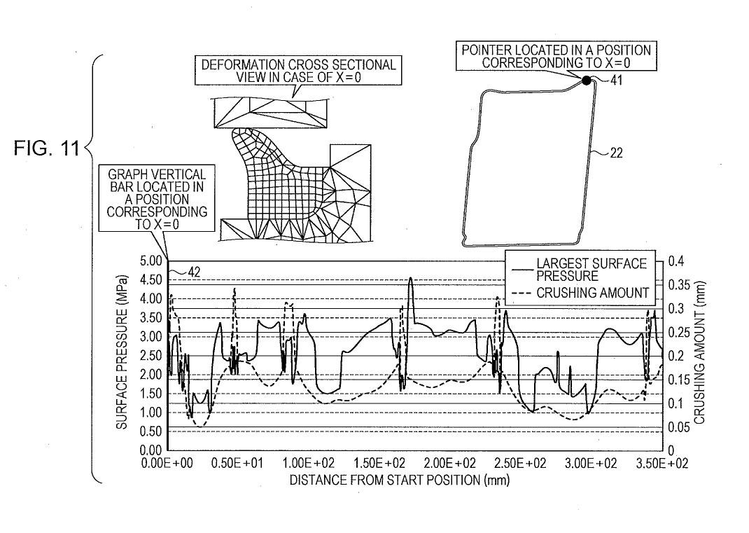

Furthermore, the result display unit 17 displays the deformation cross-sectional view illustrated in FIG. 9 and the graph illustrated in FIG. 10 in the display apparatus along with a diagram representing a position on the packing route 22 in a conjunction manner. FIG. 11 is a diagram illustrating an example of the conjunction display performed by the result display unit 17. In FIG. 11, a deformation cross-sectional view in which a distance X from the start point is 0 and a pointer 41 representing a position corresponding to “X=0” on the packing route 22 are illustrated. Furthermore, in FIG. 11, a graph vertical bar 42 located in the position corresponding to “X=0” is illustrated so as to overlap with the axis of ordinate at a left end of the graph.

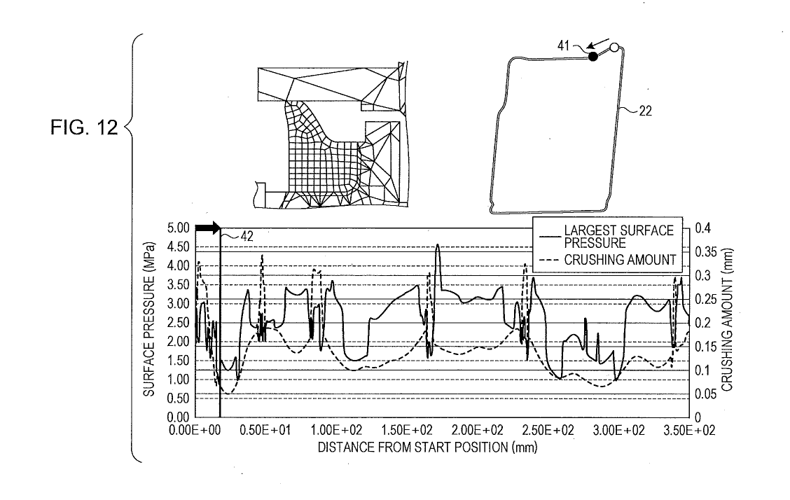

The result display unit 17 accepts an operation of moving the pointer 41 performed by the designer and performs the conjunction display of the deformation cross-sectional view and the graph. FIG. 12 is a diagram illustrating an example of conjunction display of a deformation cross-sectional view and a graph obtained when the pointer 41 is moved. As illustrated in FIG. 12, when the designer moves the pointer 41 displayed on the packing route 22, the result display unit 17 displays the deformation cross-sectional view in a cross-sectional position selected by the pointer 41 in conjunction with the movement. Furthermore, the result display unit 17 moves the graph vertical bar 42 representing the cross-sectional position in the graph in conjunction with a position of the destination of the movement of the pointer 41.

In this way, since the result display unit 17 displays the deformation cross-sectional view in conjunction with the graph in accordance with the movement of the pointer 41, the designer may easily recognize a cross-sectional position on the packing 8, a deformation cross-sectional view, a largest surface pressure, and a crushing amount in the cross-sectional position which are associated with one another.

Although a case where the display of the deformation cross- sectional view and the movement of the graph vertical bar 42 are performed in conjunction with the movement of the pointer 41 on the packing route 22 is described in FIG. 12, the display of the deformation cross-sectional view and the movement of the pointer 41 on the packing 8 may be performed in conjunction with the movement of the graph vertical bar 42.

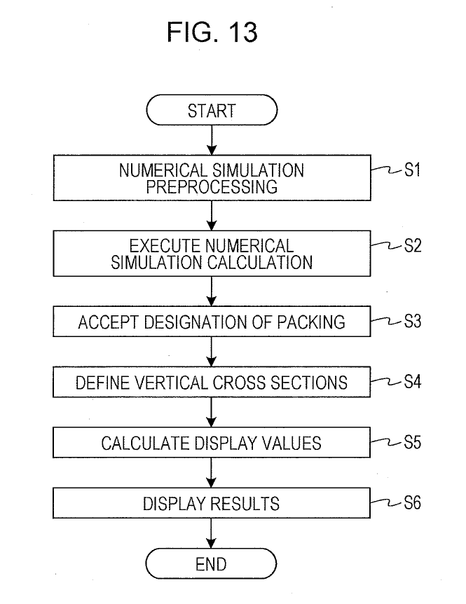

Next, a flow of a process performed by the deformation simulation apparatus 1 will be described. FIG. 13 is a flowchart illustrating the flow of the process performed by the deformation simulation apparatus 1. As illustrated in FIG. 13, the preprocessing unit 11 performs preprocessing before numerical simulation of deformation of the packing 8 is performed (step S1).

Thereafter, the calculation executing unit 12 executes numerical simulation calculation of the deformation of the packing 8 (step S2) and stores results of the execution in the analysis result storage unit 13. After the component accepting unit 14 accepts designation of the packing 8 instructed by the designer (step S3), the vertical cross-section defining unit 15 defines cross-sections vertical to the packing route 22 starting from a predetermined point at a regular interval (step S4).

The display value calculating unit 16 calculates display values, that is, largest surface pressures on and crushing amounts in positions of all the cross-sections in accordance with node information stored in the analysis result storage unit 13 (step S5).

Thereafter, the result display unit 17 displays the pointer 41 representing the start position on the packing route 22, a deformation cross-sectional view, and a graph of the largest surface pressures and the crushing amounts of the entire packing 8 in accordance with the information extracted from the analysis result storage unit 13 and the calculated display values (step S6).

Furthermore, the result display unit 17 accepts an instruction for moving the pointer 41 or the graph vertical bar 42 issued by the designer and performs conjunction display of the pointer 41, the deformation cross-sectional view, and the graph of the largest surface pressure on and the crushing amount in each of the cross-sections.

Since the result display unit 17 displays the graph of the largest surface pressure on and the crushing amount in each of the cross-sections of the entire packing 8 in this way, the designer may efficiently retrieve a portion corresponding to the smallest one of the largest surface pressures and recognize a crushing amount of the portion corresponding to the smallest one of the largest surface pressures.

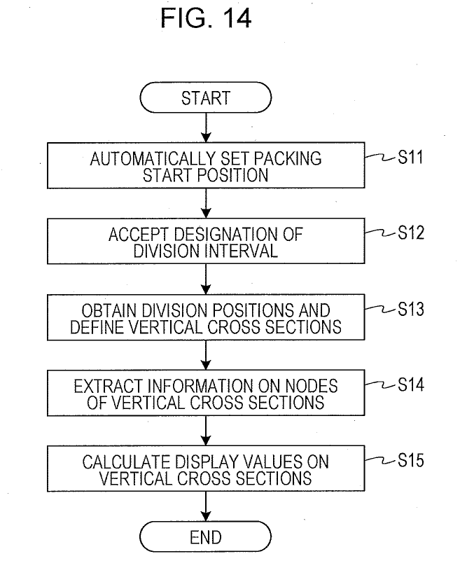

Next, a processing flow of the definition of the vertical cross-sections and the calculation of the display values will be described in detail. FIG. 14 is a flowchart illustrating a processing flow of the definition of the vertical cross-sections and the calculation of the display values. The processing flow of FIG. 14 corresponds to the process from step S4 and step S5 of FIG. 13.

As illustrated in FIG. 14, the vertical cross-section defining unit 15 automatically sets a start position on the packing 8 (step S11). Then the vertical cross-section defining unit 15 receives instruction for designation of a division interval of the packing route 22 from the designer (step S12).

Thereafter, the vertical cross-section defining unit 15 determines division positions of the packing route 22 in accordance with the division interval instructed from the designer so as to define a plurality of vertical cross-sections on the packing route 22 (step S13).

Subsequently, the display value calculating unit 16 extracts information on nodes 24 included in the each vertical cross section defined by the vertical cross-section defining unit 15 (step S14) from the analysis result storage unit 13 and calculates display values of the vertical cross-sections, that is, the largest surface pressure on and the crushing amount in each vertical cross-section (step S15).

Since the vertical cross-section defining unit 15 defines the vertical cross-sections using the division interval instructed by the designer in this way, the designer may change the number of positions at which the largest surface pressures and the crushing amounts are graphically displayed over the entire packing 8 by changing the division interval.

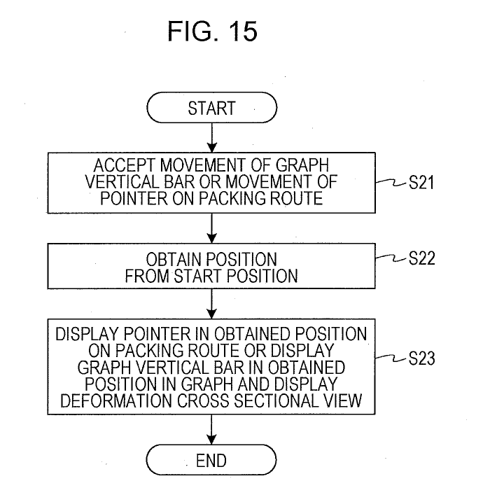

Next, a processing flow of the conjunction display performed by the result display unit 17 will be described. FIG. 15 is a flowchart illustrating the processing flow of the conjunction display performed by the result display unit 17. As illustrated in FIG. 15, the result display unit 17 accepts movement of the graph vertical bar 42 or movement of the pointer 41 on the packing route 22 instructed by the designer (step S21).

Thereafter, the result display unit 17 obtains a position of the graph vertical bar 42 or the pointer 41 on the packing route 22 which has been moved from the start position (step S22). When the graph vertical bar 42 is moved, the result display unit 17 displays the pointer 41 in the obtained position on the packing route 22 whereas when the pointer 41 is moved, the result display unit 17 displays the graph vertical bar 42 in the obtained position in the graph. Furthermore, the result display unit 17 displays a deformation cross-sectional view corresponding to the obtained position (step S23).

In this way, since the result display unit 17 displays the pointer 41 on the packing route 22 and the graph vertical bar 42 for displaying the deformation cross-sectional view, the largest surface pressures, and the crushing amounts in a conjunction manner, the designer may display various information associated with vertical cross-sectional positions by an easy operation.

As described above, in this embodiment, the calculation executing unit 12 performs simulation of deformation of the packing 8 and stores results of the simulation in the analysis result storage unit 13. Then the vertical cross-section defining unit 15 defines cross-sections vertical to the packing route 22 at a regular interval, and the display value calculating unit 16 extracts information on the nodes 24 at positions of the cross-sections defined by the vertical cross-section defining unit 15 from the analysis result storage unit 13 and calculates each of largest surface pressures and crushing amounts of each of the cross-sectional positions. Thereafter, the result display unit 17 displays the graph of the largest surface pressures and the crushing amounts of the entire packing 8 in accordance with each of the largest surface pressures and the crushing amounts in each of the cross-sectional positions.

Accordingly, the designer may efficiently retrieve a portion corresponding to the smallest one of the largest surface pressures and simultaneously recognize a crushing amount of the portion corresponding to the smallest one of the largest surface pressures. Furthermore, since the designer may recognize the largest surface pressures at the vertical cross-sectional positions of the entire packing 8 at one view, the designer is likely to find the portion corresponding to the smallest one of the largest surface pressures. Moreover, the designer may recognize change of the surface pressure in the entire packing 8.

In addition, in this embodiment, the result display unit 17 displays the deformation cross-sectional view of one of the cross-sectional positions designated by the designer along with the graph of the largest surface pressures and the crushing amounts at each the cross-sectional position. Therefore, when one of the largest surface pressures does not reach a requisite surface pressure, the designer may discuss the cause-and-effect relationship between a partial configuration and a reason that the largest surface pressure does not reach the requisite surface pressure in accordance with the deformation cross-sectional view.

Furthermore, in this embodiment, the result display unit 17 displays the pointer 41 on the packing route 22, the deformation cross-sectional view, and the graph vertical bar 42 in the graph of the largest surface pressures and the crushing amounts in the conjunction manner. Accordingly, the designer may display the information associated with the various vertical cross-sectional positions by an easy operation.

Although the deformation simulation apparatus is described in this embodiment, a deformation simulation program including an equivalent function may be obtained by realizing the configuration of the deformation simulation apparatus by software. Therefore, a computer which executes the deformation simulation program will be described.

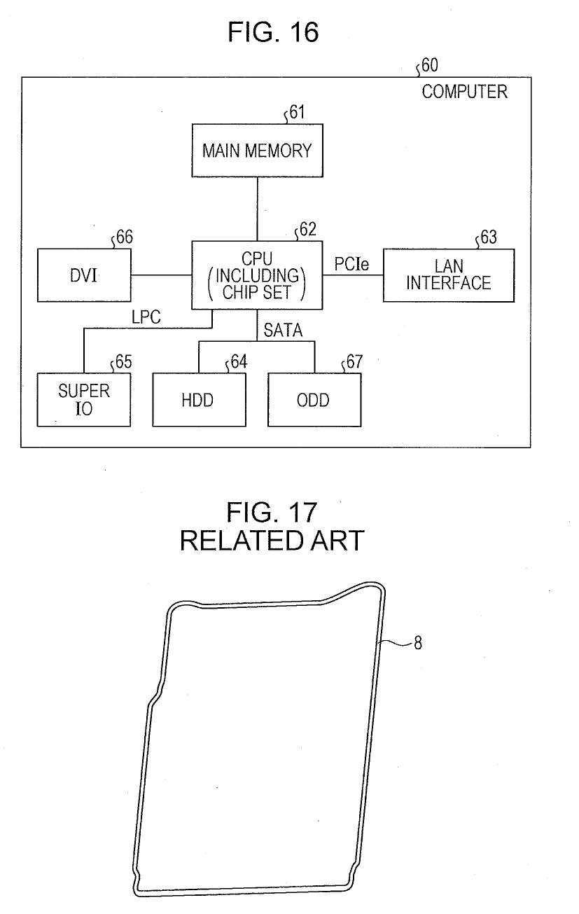

FIG. 16 is a diagram illustrating a hardware configuration of the computer which executes the deformation simulation program. As illustrated in FIG. 16, a computer 60 includes a main memory 61, a central processing unit (CPU) 62, a local area network (LAN) interface 63, and a hard disk drive (HDD) 64. The computer 60 further includes a super input/output (IO) 65, a digital visual interface (DVI) 66, and an optical disk drive (ODD) 67.

The main memory 61 stores programs and intermediate results of executed programs. The CPU 62 executes the programs read from the main memory 61. The CPU 62 includes a chip set including a memory controller.

The LAN interface 63 connects the computer 60 to other computers through a LAN. The HDD 64 is a disk device for storing programs and data. The super IO 65 is an interface for connection with input devices including a mouse and a keyboard.

The DVI 66 is used for connection of a liquid crystal display device which displays the deformation cross-sectional view, the graph of the largest surface pressures and the crushing amounts, and the pointer 41, and the ODD 67 performs reading and writing on a DVD.

The LAN interface 63 is connected to the CPU 62 through PCI Express, and the HDD 64 and the ODD 67 are connected to the CPU 62 through serial advanced technology attachment (SATA). The super IO 65 is connected to the CPU 62 through low pin count (LPC).

A deformation simulation program to be executed by the computer 60 is stored in the DVD, read from the DVD by the ODD 67, and installed in the computer 60.

Alternatively, the deformation simulation program is stored in a database of another computer system, for example, connected through the LAN interface 63, read from the database, and installed in the computer 60.

The installed deformation simulation program is stored in the HDD 64, read by the main memory 61, and executed by the CPU 62.

Although the case where the deformation of the packing 8 is simulated is described in this embodiment, the present technique is not limited to this and is similarly applicable to a case where deformation of a certain elastic body other than the packing 8 is simulated.

Although the case where the largest surface pressures are displayed in the graph is described in this embodiment, the present technique is not limited to this and is similarly applicable to a case where other values, such as smallest surface pressures, are displayed in a graph.

Although the case where the two types of value, that is, the largest surface pressures and the crushing amounts, are displayed in the graph is described in this embodiment, the present technique is not limited to this and is similarly applicable to a case where three or more types of value are displayed in a graph.

Although the case where the pointer 41 is displayed on the packing route 22 is described in this embodiment, the present technique is not limited to this and is similarly applicable to a case where the pointer 41 is displayed on display of the packing 8 or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A deformation simulation apparatus comprising:
a simulation unit configured to simulate a deformation of an elastic body to determine a plurality of simulated results, the plurality of simulated results being simulated at respective a plurality of positions in the elastic body;
a display unit configured to display a graph that is indicative of the plurality of simulated results in a manner that each of the plurality of simulated results is associated with a corresponding one of the plurality of positions over a range indicative of a whole of the elastic body.

2. The deformation simulation apparatus according to claim 1, further comprising:
a calculation unit configured to calculate a plurality of crushing amounts in respective ones of a plurality of certain directions in the elastic body by using the deformation simulated by the simulation unit, each of the plurality of crushing amounts being associated with corresponding one of the plurality of positions,
wherein the display unit displays the graph that is indicative of a relationship between the plurality of crushing amounts and the plurality of positions.

3. The deformation simulation apparatus according to claim 1, wherein
the simulation results being indicative of a plurality of surface pressures at each of contact surfaces where the elastic body is in contact with another object,
the simulation units determines the plurality of surface pressures at each of a plurality of cross-sections in associated with one of the plurality of positions,
the display unit
displays the graph that includes a plurality of largest values in a manner that each of the plurality of largest values is associated with a corresponding one of the plurality of positions, the each of the plurality of largest values being associated with a corresponding one of the plurality of surface pressures at a corresponding one of the plurality of cross-sections, the corresponding one of the plurality of surface pressures being largest among the plurality of surface pressures at the corresponding one of the plurality of cross-sections, and
displays the deformed cross-section surface, the deformed cross-section surface being indicative of the deformation of the elastic body at a one of the plurality of cross-sections.

4. The deformation simulation apparatus according to claim 2, wherein
the simulation results being indicative of a plurality of surface pressures at each of contact surfaces where the elastic body is in contact with another object,
the simulation units determines the plurality of surface pressures at each of a plurality of cross-sections in associated with one of the plurality of positions,
the display unit
displays the graph that includes a plurality of largest values in a manner that each of the plurality of largest values is associated with a corresponding one of the plurality of positions, the each of the plurality of largest values being associated with a corresponding one of the plurality of surface pressures at a corresponding one of the plurality of cross-sections, the corresponding one of the plurality of surface pressures being largest among the plurality of surface pressures at the corresponding one of the plurality of cross-sections, and
displays the deformed cross-section surface, the deformed cross-section surface being indicative of the deformation of the elastic body at a one of the plurality of cross-sections.

5. The deformation simulation apparatus according to claim 3, wherein
the display unit superimposes a position of the corresponding one of the plurality of cross-sections an display indicative of the whole of the elastic body.

6. The deformation simulation apparatus according to claim 5, wherein
the display unit receives a notification that a position of one of the plurality of cross-sections is designated on the display indicative of the whole of the elastic body and displays the deformed cross-section surface in accordance with the one of the plurality of cross-sections, the deformed cross-section surface being displayed in conjunction with the position of the one of the plurality of cross-sections, and displays the position of the one of the plurality of cross-section on the graph in a conjunction manner.

7. The deformation simulation apparatus according to claim 5, wherein
the display unit receives a notification that the position of one of the plurality of cross-sections is designated on the graph and displays the deformed cross-section surface in accordance with the one of the plurality of cross-sections in a conjunction manner, and displays the position of the one of the plurality of cross-sections on the graph in a conjunction manner.

8. The deformation simulation apparatus according to claim 1, wherein
the elastic body is a packing,
the simulation results represent a plurality of surface pressures at respective contact surfaces of the packing, the packing contacting at the respective contact surfaces with a certain object,
the simulation unit determines each of the plurality of surface pressures at a corresponding one of the plurality of contact surfaces in a cross-section which is vertical to a packing route of the packing, and
the display unit displays the plurality of surface pressures determined by the simulation unit in the graph such that the plurality of surface pressures correspond to distances from a certain start position.

9. The deformation simulation apparatus according to claim 8, further comprising:
a preprocessing unit configured to generate mesh such that nodes are positioned in the plurality of cross-sections which are vertical to the packing route representing a route extending along a shape of the packing,
wherein the simulation unit determines the plurality of surface pressures at the respective contact surfaces in the plurality of cross-sections in accordance with the mesh generated by the preprocessing unit.

10. A deformation simulation method executed by a computer, the deformation simulation method comprising:
simulating, by the computer, deformation of an elastic body to determine a plurality of results of the simulation; and
display a graph that is indicative of the plurality of results in a manner that each of the plurality of results is associated with a corresponding one of a plurality of positions in the elastic body over a range indicative of a whole of the elastic body.
